(19) United States
(12) Patent Application Publication
(10) Pub. No.: US 2022/0316723 A1
(43) Pub. Date: Oct. 6, 2022

(54) HUMIDIFIER

(71) Applicant: Shanghai Sunpai Trading Limited, Shanghai (CN)

(72) Inventor: Jianchao Xu, Shanghai (CN)

(21) Appl. No.: 17/218,178

(22) Filed: Mar. 31, 2021

(51) Int. Cl. F24F 6/10; H01R 13/70; H01R 13/72; F24F 11/00

(52) U.S. Cl. CPC F24F 6/10; H01R 13/701; H01R 13/72; F24F 11/0008

(57) ABSTRACT

The present disclosure provides a humidifier, which includes a body, a switch controlling the humidifier to turn on or off is set on the body. A connecting line and a connecting plug that can connect to a electric source are also set on the body, and the connecting switch controlling the connection to the electric source is located on the connecting line or the connecting plug. Due to the connecting switch, combining with an original on-off switch on the humidifier body, the humidifier can be controlled by double switches, thereby improving of the convenience of the use of the humidifier.

### TECHNICAL FIELD

The present disclosure relates to a technical field of air treatment equipment, and particularly relates to a double-switch humidifier which is convenient for storage.

### BACKGROUND

A humidifier is a household appliance that increases the humidity of a regional space. It can humidify the space in a certain area, and can also be connected to the boiler or central air conditioning system to humidify an entire building. Therefore, humidifiers can be divided into two types of humidifiers by the use, the household humidifier and industrial humidifier. Air humidifiers are still from an emerging industry in China. According to statistics, the per capita share of humidifier products in China is far lower than that of developed countries such as the United States, South Korea, and Japan. Therefore, the research and development of air humidifiers should be increased, so as to the development of the household air humidifier industry, but also to the improvement of the quality of life of the people and the improvement of the national health level.

Currently, for conventional household humidifiers (especially vehicle-mounted humidifiers), there are still certain flaws in the structure, which causes inconvenience to use and storage, and reduces the convenience of use.

### SUMMARY

### Technical Problems

In view of the shortcomings of the prior art, the present disclosure provides a double-switch humidifier that is convenient to store. The double-switch humidifier aims to solve the technical problems of the inconvenience of the conventional humidifiers in use and storage. The humidifier has a connecting switch set on the connecting plug or the connecting line, combining with an original on-off switch on the humidifier body, the humidifier can be controlled by double switches, thereby improving of the convenience of the use of the humidifier.

### Technical Solution

The present disclosure provides a humidifier, which includes a body, a switch controlling the humidifier to turn on or off is set on the body. A connecting line and a connecting plug that can connect to a electric source are also set on the body, and the connecting switch controlling the connection to the electric source is located on the connecting line or the connecting plug.

Since the connecting switch is set on the connecting line or the connecting plug, the power on or off to the electric source can be controlled, thereby controlling the turning on or off of the humidifier. Meanwhile, a on-off switch on the body is also set to control the humidifier to turn on or off, which means the humidifier can be double-switched, improving the convenience of use.

Preferably, the body further has a winding storage portion for winding and storage the connecting line and the connecting plug. The connecting line and the connecting plug can be winded and stored in the winding storage portion, such that the connecting line and the connecting plug are hided while the humidifier is not used, and the humidifier can be easily stored.

Additionally, the winding storage portion is located at a bottom part of the body, further improving the convenience of storage.

Additionally, the connecting line and the connecting plug are connected to a lower part of the body. Therefore, the connecting line and the connecting plug can better engage with the winding storage portion, facilitating to the storage of the connecting line and the connecting plug.

Preferably, the connecting switch turns on or turns of via pressing, facilitating to powering on or off the humidifier.

Preferably, the connecting switch is provided on the connecting plug, and the connecting plug is an USB plug. Therefore, the connecting switch can be used more easily, and the adaptability of the humidifier is improved by the USB plug, such that the humidifier can be connected to a computer or a panel in the car.

### Beneficial Effects

Since the humidifier has a connecting switch set on the connecting plug or the connecting line, the power of the humidifier can be controlled by the connecting switch, such that the humidifier can be turned on or off. Moreover, combining with an original on-off switch on the humidifier body, the humidifier can be controlled by double switches, thereby improving of the convenience of the use of the humidifier.

### BRIEF DESCRIPTION OF THE DRAWINGS

To illustrate the technical solutions according to the embodiments of the present disclosure or in the prior art more clearly, the accompanying drawings for describing the embodiments or the prior art are introduced briefly in the following. Apparently, the accompanying drawings in the following description are only some embodiments of the present disclosure, and persons of ordinary skill in the art can derive other drawings from the accompanying drawings without creative efforts.

FIG. 1 is a perspective view of a humidifier according to an embodiment of the present disclosure, in which the connecting line and the connecting plug are unwound;

FIG. 2 is a bottom view of FIG. 1;

FIG. 3 is a perspective view of a humidifier according to an embodiment of the present disclosure, in which the connecting line and the connecting plug are winded and stored; and

FIG. 4 is a bottom view of FIG. 3.

### REFERENCE NUMBER

1—body, 1a—switch, 1b—connecting line, 1c—USB plug, 2—connecting switch.

### DETAILED DESCRIPTION OF THE EMBODIMENTS

The present disclosure will be further described in detail below with reference to the drawings. A preferred embodiment is described in the drawings. However, the present disclosure can be implemented in many different forms and is not limited to the embodiments described herein. Rather, these embodiments are provided to provide a thorough understanding of the present disclosure. The specific embodiments are only explanations of the present disclosure, and the embodiments are not intended to limit the present disclosure. Rather, various modifications may be made in the details within the scope and range of equivalents of the claims and without departing from the present disclosure.

### Embodiment 1

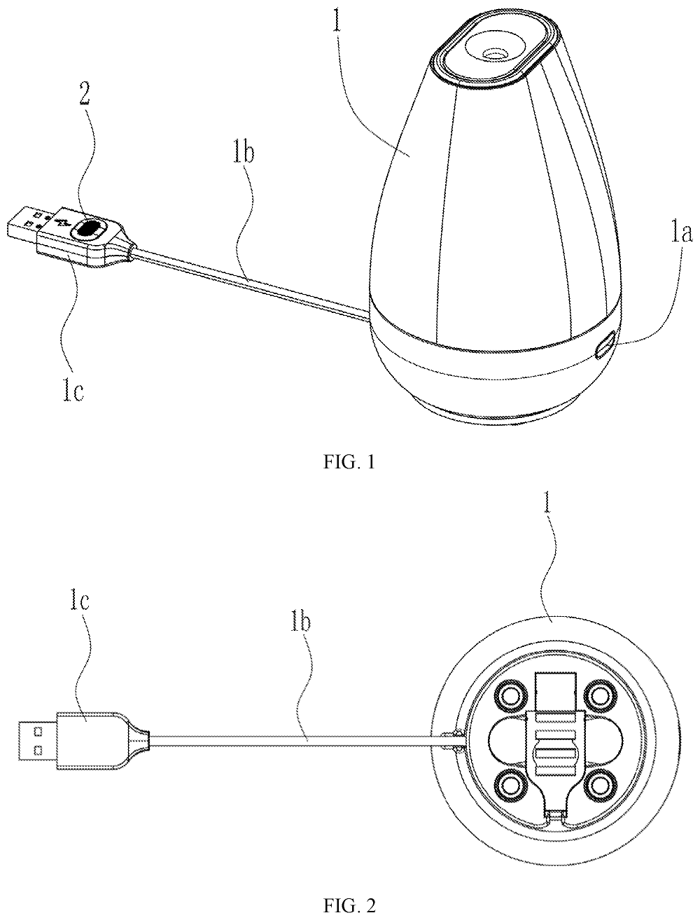

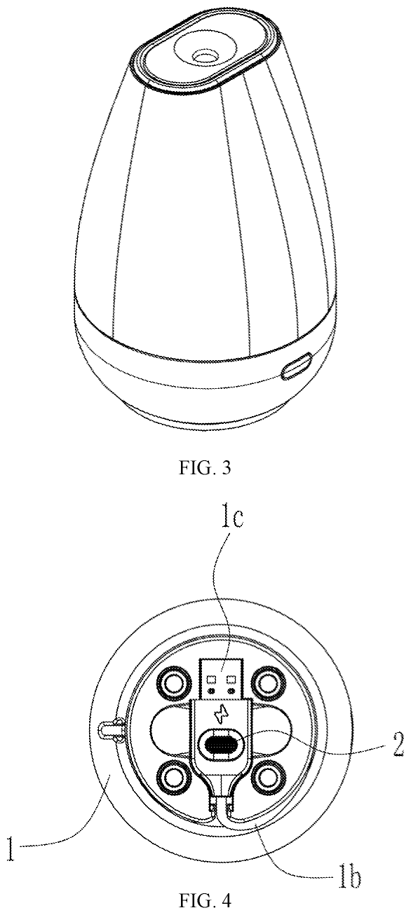

A double-switch humidifier of the embodiment includes a body 1, and a switch 1a for controlling the humidifier to turn on or off is set on the body 1. Additionally, a connecting line 1b and an USB plug 1c used to connect to an electric source are also located on the body 1. A connecting switch 2 for controlling the connection to the electric source is located on the USB plug 1c, and the connecting switch 2 turns on or turns of by pressing. FIG. 1 shows a perspective view of the humidifier with the connecting line 1b and the USB plug 1c unwound, and FIG. 2 is a bottom view of FIG. 1. FIG. 3 shows a perspective view of the humidifier with the connecting line 1b and the USB plug 1c winded and stored, and FIG. 4 is a bottom view of FIG. 3.

Additionally, the body 1 further has a winding storage portion for winding and storage the connecting line 1b and the USB plug 1c. The winding storage portion is located at a bottom part of the body 1, and the connecting line 1b and the USB plug 1c are connected to the lower part of the body 1.

### Embodiment 2

The present embodiment provides a double-switch humidifier, which includes a body, a switch for controlling the humidifier to turn on or off is provided on the body, and a connecting line and an USB plug for connecting to an electric source are also set on the body. A connecting switch for controlling the connection to the electric source is located on the connecting line, and the connecting switch turns on or turns of by pressing.

Additionally, the body further has a winding storage portion for winding and storage the connecting line and the USB plug. The winding storage portion is located at a bottom part of the body, and the connecting line and the USB plug are connected to the middle part of the body.

### Embodiment 3

The present embodiment provides a double-switch humidifier, which includes a body, a switch for controlling the humidifier to turn on or off is provided on the body, and a connecting line and a two-phase power plug for connecting to an electric source are also set on the body. A connecting switch for controlling the connection to the electric source is located on the two-phase power plug, and the connecting switch turns on or turns of by pressing.

Additionally, the body further has a winding storage portion for winding and storage the connecting line and the two-phase power plug. The winding storage portion is located at a bottom part of the body, and the connecting line and the two-phase power plug are connected to the middle part of the body.

Since the connecting switch is set on the connecting line or the connecting plug, the power on or off to the electric source can be controlled, thereby controlling the turning on or off of the humidifier. Meanwhile, a on-off switch on the body is also set to control the humidifier to turn on or off, which means the humidifier can be double-switched, improving the convenience of use.

Moreover, the connecting line and the connecting plug can be winded and stored in the winding storage portion, such that the connecting line and the connecting plug are hided while the humidifier is not used, and the humidifier can be easily stored.

The specific embodiments are only explanations of the present disclosure, and the embodiments are not intended to limit the present disclosure. Rather, various modifications may be made in the details within the scope and range of equivalents of the claims and without departing from the present disclosure. The scope of this present disclosure is not limited to the content of the description, and its technical scope shall be determined according to the scope of the claims.

In addition, it should be understood that although this specification is described in accordance with each of the embodiments, not each embodiment only contains an independent technical solution. The technical solutions in the various embodiments can also be appropriately combined to form other embodiments that can be understood by those skilled in the art without creative efforts.

What is claimed is:

1. A humidifier, comprising a body, a switch being capable of controlling the humidifier to turn on or off is provided on the body, and a connecting line and a connecting plug being capable of connecting to an electric source are also provided on the body, a connecting switch being capable of controlling the connection to the electric source is located on the connecting line or the connecting plug.

2. The humidifier according to claim 1, wherein the body further defines a winding storage portion being capable of winding and storage the connecting line and the connecting plug.

3. The humidifier according to claim 2, wherein the winding storage portion is located at a bottom part of the body.

4. The humidifier according to claim 3, wherein the connecting line and the connecting plug are connected to a lower part of the body.

5. The humidifier according to claim 1, wherein the connecting switch turns on or turns of via pressing.

6. The humidifier according to claim 1, wherein the connecting switch is provided on the connecting plug, and the connecting plug is an USB plug.
